(19) United States
(12) Patent Application Publication
(10) Pub. No.: US 2024/0290126 A1
(43) Pub. Date: Aug. 29, 2024

(54) Methods, Systems and Computer Program Products for Determining Date Information

(71) Applicant: Xero Limited, Te Aro (NZ)

(72) Inventors: Bryan Obright, Te Aro (NZ); Alan Oberg, Te Aro (NZ)

(21) Appl. No.: 18/588,500

(22) Filed: Feb. 27, 2024

(30) Foreign Application Priority Data
Feb. 28, 2023 (AU) 2023900523

(51) Int. Cl. G06V 30/416; G06Q 40/12; G06V 30/10; G06V 30/42

(52) U.S. Cl. CPC G06V 30/416; G06Q 40/128; G06V 30/10; G06V 30/42; G06V 2201/10

(57) ABSTRACT

A method comprises: determining a first candidate date string from a document; determining that the first candidate date string corresponds with two or more valid dates; determining a document date value of the document; determining a relevant date range based on the document date value; determining that at least one of the two or more valid dates falls within the relevant date range; and responsive to determining that at least one of the two or more valid dates falls within the relevant date range, determining the at least one of the two or more valid dates as an inferred date for the first candidate date string.

### TECHNICAL FIELD

The present disclosure relates to methods, systems and computer program products for determining date information from documents, such as financial or accounting documents. Some embodiments relate to resolving ambiguities in determined date information.

### BACKGROUND

Date information of financial and/or accounting documents is an important variable by which transactions can be ordered, understood, accounted for and/or reconciled with corresponding records. Accordingly, determining accurate date information from financial and/or accounting documents is important for tracking funds and transaction history of an entity.

It is desired to address or ameliorate one or more shortcomings or disadvantages associated with prior art systems and/or methods, or to at least provide a useful alternative hereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments are directed to a method comprising: determining a first candidate date string from a document; determining that the first candidate date string corresponds with two or more valid dates; determining a document date value of the document; determining a relevant date range based on the document date value; determining that at least one of the two or more valid dates falls within the relevant date range; and responsive to determining that at least one of the two or more valid dates falls within the relevant date range, determining the at least one of the two or more valid dates as an inferred date for the first candidate date string.

In some embodiments, the document date value is a date of issuance of the document. In some embodiments, the relevant date range extends over a fixed period of time from a start date to the date of issuance of the document. In some embodiments, the document date value comprises the relevant date range.

In some embodiments, the method according to any of the present disclosures further comprises: providing, as an output, the inferred date for the first candidate date string.

In some embodiments, the method according to any of the present disclosures further comprises: determining that at least two of the two or more valid dates falls within the relevant date range; and responsive to determining that at least two of the two or more valid dates falls within the relevant date range, determining the at least two of the two or more valid dates as a set of inferred dates for the first candidate date string.

In some embodiments, the method according to any of the present disclosures further comprises: providing, as an output, the set of inferred dates for the first candidate date string.

Some embodiments are directed to a method comprising: determining a first candidate date string from a document, wherein the first candidate date string forms part of a first item of a plurality of items in the document; determining that the first candidate date string corresponds with two or more valid dates; responsive to determining that the first candidate date string corresponds with two or more valid dates, determine one or more further candidate date strings from the document, wherein each of the one or more further candidate date strings form part of a respective further item of the plurality of items in the document; and determining at least one valid date for at least one of the one or more further candidate date strings; and determining an inferred date for the first candidate date string based on the determined at least one valid date for the at least one of the one or more further candidate date strings.

In some embodiments, wherein determining one or more further candidate date strings from the document comprises determining a plurality of further candidate date strings from the document, and wherein the at least one valid dates of each of the plurality of further candidate date strings comprises at least a first digit in a first position and a second digit in a second position, wherein the first digit represents a month or a year, the method further comprises: determining a greatest number of the plurality of further candidate date strings having a same first value for the first digit of the respective valid dates; responsive to determining that first value corresponds to a value of a digit of the candidate date string, inferring that the first digit is the month or year of the candidate date string.

In some embodiments, the plurality of items are ordered in date order from earliest date to latest date, wherein determining one or more further candidate date strings from the document comprises determining a first further candidate date string, and wherein the method further comprises: determining that the first further candidate date string precedes or follows the candidate date string in the order of the plurality of items; and determining an inferred date for the first candidate date string based on the determined at least one valid date for the first further candidate date string and whether it precedes or follows the candidate date string.

In some embodiments, wherein the plurality of items are ordered in date order from earliest date to latest date, wherein determining one or more further candidate date strings from the document comprises determining a first further candidate date string and a second further candidate date string from the document, and wherein the first further candidate date string precedes the candidate date string in the plurality of items, and the second further candidate date string follows the candidate date string in the plurality of items, the method further comprises: determining an inferred date for the first candidate date string based on the determined at least one valid date for the first further and the second further candidate date string.

In some embodiments, determining at least one valid date for at least one of the one or more further candidate date strings comprises determining a unique valid date for the first further and/or the second further candidate date string.

In some embodiments, the method according to any one of the present disclosures further comprises: receiving document data indicative of the date value of the document; and wherein determining the document date value is based on the received document data.

In some embodiments, the document data is determined from previously processed documents. In some embodiments, the document data comprises one or more of: a document type; a document title; a document issuance date; a document creation date; a document date range; an indication of an entity that created the document; and/or an indication of one or more entities associated with the document.

In some embodiments, the method according to any one of the present disclosures further comprises: determining date parsing metadata; and wherein determining the document date value of the document is based on the received document data and the date parsing metadata.

In some embodiments, the date parsing metadata comprises: year clarity; a date element order; an indication of characters that have been removed from the first candidate date string and/or one or more further candidate date strings; a set of date formats; and/or a confidence rating.

In some embodiments, the method according to any one of the present disclosures further comprises: determining a second candidate date string from the document; determining that the second candidate date string corresponds with a valid and unique date; and responsive to determining that the second candidate date string corresponds with a valid and unique date; determining the valid and unique date as an inferred date for the second candidate date string.

Some embodiments are directed to a system comprising: one or more processors; and memory comprising computer executable instructions, which when executed by the one or more processors, cause the system to perform the method of any one of the present disclosures.

Some embodiments are directed to a computer-readable storage medium storing instructions that, when executed by a computer, cause the computer to perform the method of any one of the present disclosures.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

FIG. 1 is a broad overview of a method for determining date information from a document, according to some embodiments;

FIG. 2 is a block diagram of a system for determining date information from documents, according to some embodiments;

FIG. 3 is a process flow diagram of a method for determining date information, according to some embodiments;

FIG. 4 is a process flow diagram of a method for determining date information, according to some embodiments;

FIG. 5 is an example image of a financial document from which date information may be determined, according to some embodiments; and

FIG. 6 is an example image of a financial document from which date information may be determined, according to some embodiments.

### DESCRIPTION OF EMBODIMENTS

The present disclosure relates to methods, systems and computer program products for determining date information from documents, such as financial or accounting documents. Some embodiments relate to resolving ambiguities in determined date information.

Date information is a useful attribute by which information contained in documents, such as financial documents or accounting documents for example, may be ordered or otherwise organised. For example, in the act of accounting or bookkeeping, such as balancing books, corresponding debits and credits may need to be reconciled with financial transaction to ensure that the financial/business activity of an entity is properly tracked. This may comprise comparing an invoice of a particular amount and particular date, with an item on a statement line of a financial record having a particular amount and particular date. By being able to readily and automatically discern dates from documents many downstream activities, such as transaction reconciliation processes, may be improved, streamlines and/or made more efficient.

Documents may comprise date information organised in numerous ways. In general, documents may comprise a collection, set or plurality of entries/elements. The elements may comprise data indicative of an action. The data indicative of the action may comprise date information. The date information may comprise a date the action was initiated/performed, and/or a date the action was completed, accepted and/or validated. The data indicative of an action may comprise a description of the action and/or one or more entities associated with the action. The data indicative of an action may comprise any other type of information that is relevant to the type, nature, occurrence, and/or associated entities of the action. In some embodiments, the collection or of elements may comprise a single element.

The collection, set or plurality of elements and/or the date information of each of the collection, set or plurality of elements may be interrelated or otherwise have an order and/or structure to them and/or their organisation and presentation in the document. In some embodiments, the elements may be interrelated and/or ordered based on the nature or type of the document, additional data contained within the document and/or the elements themselves. In other words, the collection, set or plurality of elements may be an ordered collection, set or plurality of elements. In some embodiments, the ordering of the collection, set or plurality of elements is temporal, such as being based on the date information of the elements. For example, the elements may be ordered by a date of occurrence, a date of receipt, a date of sending, a date of confirmation, a date of approval, a date of rejection and/or any other type of date by which an ordered plurality of elements may be arranged.

The elements and accordingly the data indicative of an action comprised therein will be associated and/or have a shared context. The shared context may be determined by the document, the elements and/or any other data, attributes or qualities of the document or its contents.

Documents may comprise a list of transactions between one bank account and other bank accounts. The list of transactions may comprise single line items, or otherwise list items/entries that comprise various information regarding a particular transaction, such as amount, recipient and date. However, it is not just financial data that may be listed in a document with accompanying date information. Stock lists that take account of stock levels and when stock entries or leaves a stock holding location also list the changes in stock with a relevant date on which the stock either left or arrived at the location. Another example of lists that may comprise date information for all if not substantially most of the list entries, would be check-in/check-out data for a location, which may be recorded to keep account of who has visited a location and when. It will be understood by the person skilled in the art that any reference to the term line item may be interchangeable with the term list item, while still describing an entry in a list configured to record some type of information.

Coding statements to a specific format would require custom configuration for every supported statement variation. However, date parsing without knowing the date format used in a document presents a number of challenges. For example, many date formats used within financial statements include the following problems: omitted years, ambiguous month and day ordering, numerous standard and non-standard formats (e.g. 1028), ordinal usage (e.g. July 2nd), day of week usage, and/or mixed formats within a single document. The typical Date Parser functions provided by date libraries do not address these issues. They simply parse the provided string with the first common format that is feasible. Missing elements may result in defaulted values or a failed parsing.

The described embodiments provide improved methods, systems and computer program products for determining date information from documents that do not require prior knowledge of the date format(s) being used in the document.

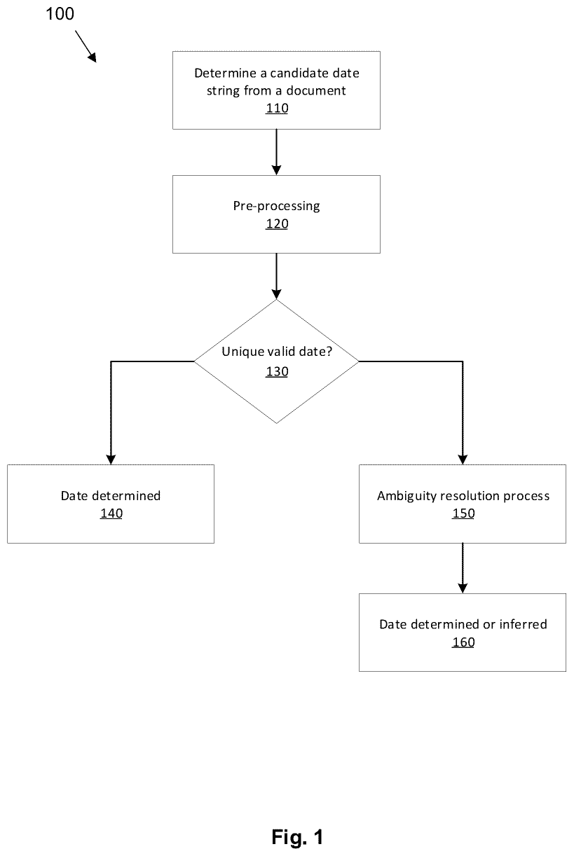

FIG. 1 is a schematic overview of a process flow 100 for a technique of determining date information from a document, according to some embodiments. For example, the document may be a financial document such as a financial statement, an accounting document, such as an invoice or bill, or some other document type comprising one or more dates to be determined.

At 110, a candidate date string is determined from a document. Determining the date string may comprise extracting, using a machine learning model, strings of characters, digits and/or symbols from the document. The candidate date string may be alphanumerical, or may comprise digits, text, or other symbols such as hyphens, dashes, forward and/or backward slashes, full stops, brackets and/or commas.

At 120, the candidate date string may be subjected to pre-processing techniques. For example, any constructs such as ordinals (e.g. st, nd, th etc.) or days of the week (Tue, Tuesday etc.) may be removed from the candidate date string.

At 130, the candidate date string is assessed to determine whether a unique valid date can be determined or associated with the candidate date string. A unique valid date may be an unambiguously valid date. For example, some date formats are unambiguous, and include a definitive mapping of the day, month and year, such as 10 January 2023. Definitive date formats may be divided into the two groups when considering dates with day and month: “day then month” and “month then day”. Definitive date formats may be divided into the following four groups when considering dates with day, month and year: “day, then month, then year” and “year, then month, then day”, “month, then day, then year” “year, then day, then month”. Example definitive date formats with year include:
Month then Day
   MMM dd, yyyy—Jan 01, 2021
   MMMM d, yyyy—January 1, 2021
   yyyy MMM d—2021 Jan 1
   yyyy MMMM dd—2021 January 01
   MMM d/yy—Jan 1/21
   MMM dd/yy—e.g. Jan 01/21
   Month then Day with Day of Week
      dddd, MMMM dd, yyyy—Tuesday, June 01, 2018
      ddd. MMMM d, yyyy—Tue. June 1, 2018
      dddd MMM dd, yyyy—Tuesday Jun 1, 2018
      ddd MMM d, yyyy—Tue 1 Jun 1, 2018
Day then Month
   d MMM yyyy—1 Jan 2021
   dd MMM yyyy—01 Jan 2021
   d MMMM yyyy—1 January 2021
   dd MMMM yyyy—01 January 2021
   Day then Month with Day of Week
      dddd, dd MMMM, yyyy—Tuesday, 1 June 2018
      ddd. dd MMMM, yyyy—Tue. 01 June 2018
      dddd dd MMM, yyyy—Tuesday 01 Jun, 2018
      ddd dd MMM, yyyy—Tue 01 Jun, 2018

In some embodiments, definitive dates may be divided into more than, or fewer than the four groups described above. The definitive dates may be divided into any one or more of “day, then month, then year”, “year, then month, then day”, “month, then day, then year” and “year, then day, then month”. In some embodiments, the definitive dates may not be divided into any of the groups selected from “day, then month, then year” and “year, then month, then day”, “month, then day, then year” “year, then day, then month”, rather, they may be divided into different groups that are not one of the four groups described above, such as “month, then year, then day”. In some embodiments, the definitive dates may be divided into all known or possible combinations of day, month and year.

In some embodiments, the definitive dates may be separated into two or more sets of groups. For example, the definitive dates may be separated into a first group and second group. The first group may be indicative of the date formats “day, then month, then year” and “year, then month, then day”. The second group may be indicative of the date formats “month, then day, then year” “year, then day, then month”. The definitive dates may be separated into any number of sets of groups, each group comprising any number of date formats.

At 140, responsive to determining that the candidate date string is a unique valid date (i.e. an unambiguous date), determining the date of the candidate date string as being the determined unique valid date.

However, some dates are ambiguous. There may be multiple valid (i.e. real) dates that match the candidate date string. For example, ambiguous date may take a date format in which the mapping of the month, day, and/or year is not deterministic simply by the format. These formats may produce an ambiguous result, or a non-deterministic result. A format which is non-deterministic may be resolved into a deterministic result due to the validity of each possible mapping, for example, by performing an ambiguity resolution process, at 150. For example, a part or element of a candidate date string greater than 12 can only be the day of month or year. This allows for some certainty of results not deterministic based on format alone. According to some embodiments, determination of a valid date may comprise an assessment of a combination of the individual parts or elements of a candidate date string to resolve ambiguity, or otherwise determination validity. For example, 29 February is an invalid date for all years that are not a leap year. Accordingly, determining that 29 February is a valid date may comprise determining that the year is a leap year.

Example ambiguous date formats with year include:
Month then Day
   yyyy/MM/d—2001/01/1
   yyyy/MM/dd—2001/01/01
   MM/d/yyyy—01/01/2001
   MM/dd/yyyy—01/01/2001
   M/d/yyyy—1/01/2001
   M/dd/yyyy—1/01/2001
   yy/MM/dd—01/01/01
   yy MMM dd—17 Jan 1
Day then Month
   yyyy/d/MM—2001/01/1
   yyyy/dd/MM—2001/01/01
   d/MM/yyyy—01/01/2001
   dd/MM/yyyy—01/01/2001
   yy/d/MM—01/1/01
   yy/dd/MM—01/01/01
   d/MM/yy—01/1/01
   dd/MM/yy—01/01/01
   dd MMM yy—12 Jan 17
   d MMM yy—2 Jan 17

The ambiguity resolution process 150 may be performed according to the methods 300 and/or 400 as described in detail below. Once the ambiguity resolution process 150 has been performed, a determined or inferred date for the candidate date string is determined or inferred, and may be provided as an output to a user, or to an application, for example, for downstream processing, such as performing an automated reconciliation action in an accounting system.

In some embodiments, where the ambiguity resolution process 150 does not determine or infer one date, but instead the resolution process 150 returns two or more dates, which may be substantially equally likely, the two or more determined/inferred dates may be provided. The date parsing metadata may, in some embodiments, also output two or more determined/inferred dates, the date parsing meta data my comprise year clarity (e.g. the number of digits the string element that was determined to be indicative of year comprised), a date element ordering, a list of potential and/or considered date formats, for example. Date element ordering may comprise an indication of the order in which the date elements are arranged. Date elements may be an indication of a day of the week, a day of the month, a month or a year. Accordingly, a date element ordering may indicate that the indication of the day of the month has been determined to be first in the string, the indication of the month has day has been determined to be second in the string, in otherwise after the indication of the ay of the month, and the indication of the year has been determined to be last, or third in the string, or otherwise after both the indication of the day of the month and the indication of the month.

In some embodiments, the date parsing metadata may comprise an indication of a level of confidence, in other words a confidence rating, for the determined dates. For example, if the document comprises 10 elements, and each of the candidate date strings of 9 of the 10 elements were determined to have a format of “dd/MM/yyyy”, the metadata may comprise an indication that the date determinations have a 90% confidence rating. A higher confidence rating may be indicative of the level of accuracy and/or correctness of the date determinations.

Using the two or more determined/inferred dates, the date parsing metadata and/or additional document data, additional date resolution determination may be performed, subsequent to and/or in addition to the ambiguity resolution process 150. Additional document data may comprise: a document type, such as an invoice, a statement of account, and/or a transaction list; additional document date range dates, such as early payment dates, penalty dates and/or previous payment dates; and/or an entity that generated or is associated with the document, such as a bank or other financial institution. The date parsing metadata in combination with the additional document data may be used to exclude one or more of the two or more determined/inferred dates. For example, if the additional document data indicates that the document is an annual document, such as an annual invoice, and/or annual account of transactions, dates of the two or more determined/inferred dates that fall outside of a year from the date of issue of the document may be disqualified.

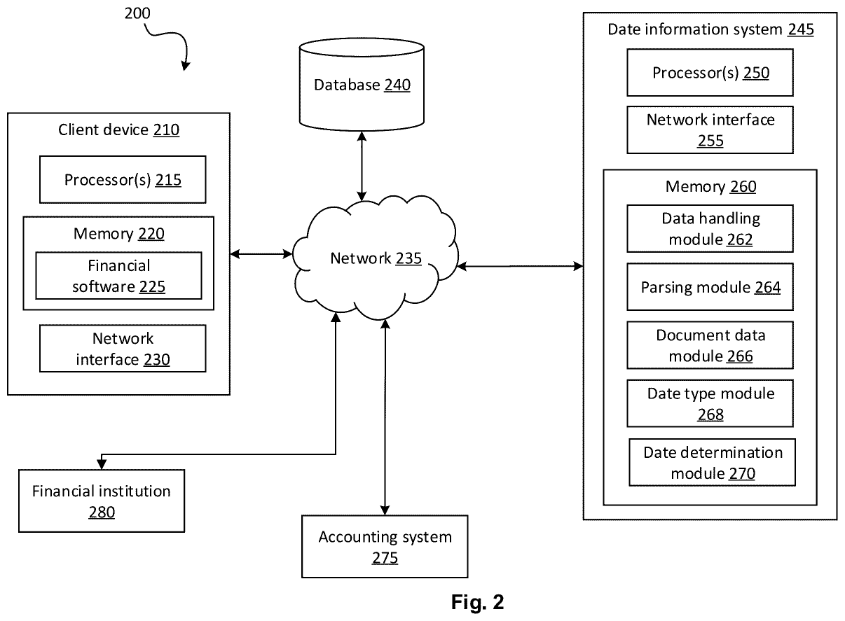

FIG. 2 is a block diagram of a system 200 for determining date information, according to some embodiments. System 200 may comprise client device 210, network 235, database 240, date information system 245, accounting systems 275, financial institution 280 and/or third party server (not shown).

In some embodiments, the client device 210 may comprise a mobile or handheld computing device such as a smartphone or tablet, a laptop, or a PC, and may, in some embodiments, comprise multiple computing devices. The client device 210 may comprise processor 215, memory 220 and/or network interface 230. The memory 220 may comprise financial software 225 or a financial software suite configured to receive and/or process financial documents for processing by date information system 245. In some embodiments, the financial documents may be .PDF, .HTML, and/or .XPS, or any other plain text format. Client device 210 may be configured to capture an image of a physical financial document, such as a paper print out, such that the image may be uploaded to financial software 225 for processing. In some embodiments the financial software 225 may be configured to communicate with other software contained in the memory 220 of the client device 210 to receive financial documents and/or accounting documents.

The processor(s) 215 may comprise one or more microprocessors, central processing units (CPUs), application specific instruction set processors (ASIPs), application specific integrated circuits (ASICs) or other processors capable of reading and executing instruction code.

The memory 220 may comprise one or more volatile or non-volatile memory types. For example, memory 220 may comprise one or more of random access memory (RAM), read-only memory (ROM), electrically erasable programmable read-only memory (EEPROM) or flash memory. Memory 220 is configured to store program code accessible by the processor(s) 220. The program code comprises executable program code modules. In other words, memory 220 is configured to store executable code modules configured to be executable by the processor(s) 215. The executable code modules, when executed by the processor(s) 215 cause the client device 210 to perform certain functionality, as described in more detail below. For example, memory 220 may comprise financial software 225.

The network interface 230 facilitates communications between client device 210 and other components of system 200, such as database 240, date information system 240, accounting systems 275, financial institution 280 and/or third party server(s) (not shown), via network 235. The network interface 230 may comprise a combination of network interface hardware and network interface software suitable for establishing, maintaining and facilitating communication over a relevant communication channel.

The network 235 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 235 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The database 240, which may form part of or be local to the system 200, or may be remote from and accessible to the system 200, for example, via the network 235. The database 240 may be configured to store data associated with the system 200. The database 240 may be a centralised database. The database 240 may be a mutable data structure. The database 240 may be a shared data structure. The database 240 may be a data structure supported by database systems such as one or more of PostgreSQL, MongoDB, and/or ElasticSearch. The database 240 may be configured to store a current state of information or current values associated with various attributes (e.g., “current knowledge”).

The date information system 245 may comprise processor(s) 250, network interface 255, and memory 260. The date information system 245 may be configured to receive documents, such as from client device 210, database 240, financial institution 280 and/or accounting systems 275 via network 235, and determine, from the documents, date information. For example, the date information may comprise valid document data which is indicative of dates over which the contents of the documents, such as transactions, itineraries, stock counts, and/or purchased goods/services, were performed, processed and/or confirmed.

The processor(s) 250 may comprise one or more microprocessors, central processing units (CPUs), application specific instruction set processors (ASIPs), application specific integrated circuits (ASICs) or other processors capable of reading and executing instruction code.

The network interface 255 facilitates communications between date information system 245 and other components of system 200, such as client device 210, database 240, accounting systems 275, financial institution 280 and/or third party server(s) (not shown), via network 235. The network interface 255 may comprise a combination of network interface hardware and network interface software suitable for establishing, maintaining and facilitating communication over a relevant communication channel.

The memory 260 may comprise one or more volatile or non-volatile memory types. For example, memory 260 may comprise one or more of random access memory (RAM), read-only memory (ROM), electrically erasable programmable read-only memory (EEPROM) or flash memory. Memory 260 is configured to store program code accessible by the processor(s) 250. The program code comprises executable program code modules. In other words, memory 260 is configured to store executable code modules configured to be executable by the processor(s) 250. The executable code modules, when executed by the processor(s) 250 cause the date information system 245 to perform certain functionality, as described in more detail below. For example, memory 260 may comprise data handling module 262, parsing module 264, context module 266, date type module 268, ambiguity module 270, and/or date determination module 272.

The data handling module 262 is configured to receive data, such as documents and/or additional document data, from client device 210, database 240, accounting systems 275 financial institution 280 and/or third party server(s) (not shown), directly, or via network 235. Data handling module 262 may perform data checking, and/or sanitisation. For example, data handling module 262 may be configured to remove and/or request retransmission of corrupted and or partially transferred document files. In some embodiments, data handling module 262 may be configured to alert a user of the system 200, such as a user of financial software 225, if one or more provided documents do not pass the data checking and/or processing sanitisation.

The parsing module 264 is configured to parse or otherwise analyse the document to determine a document date information region, and/or a item region, such as a line item region. Parsing module 264 is configured to determine, in document date region, candidate document date information. In some embodiments, parsing module 264 is configured to determine, from the item region, candidate item date information, such as candidate line item date information. Parsing module 264 is configured, in some embodiments, to communicate the determined candidate document date information and/or candidate item date information to the date determination module 270, for processing.

The document data module 266 is configured to receive, store and/or process additional document data from data handling module 262. The additional document data may comprise a document type, document title, document generation entity, and/or document metadata. The document data module may be configured, in some embodiments, to work in conjunction with date determination module 270 to facilitate the determination of valid dates from the various candidate date information.

The date type module 268 is configured to store and retrieve a set of known date formats for use in determining dates, according to described embodiments. The date type module may comprise a plurality of date formats comprising one or more of a day of the week notion style, day of the month notation style, a month notational style and/or a year notation style. The date determination module 270 and/or the parsing module 264 may be in communication with date type module 268 to retrieve date formats to perform the disclosed methods.

The date determination module 270 is configured to determine, from candidate strings, one or more valid and/or unique dates. Date determination module 270 may comprise one or more machine trained models capable of optical character recognition, or otherwise determining text from a document. Date determination module 270 may be configured to analyse a candidate date string to determine one or more date elements, such as a potential indication of a day of the month, a potential indication of a month and/or a potential indication of a year. In some embodiments, date determination module 270 may be configured to determine whether a candidate string comprises an ordinal number, and remove the suffix from the ordinal number to turn the ordinal number into a cardinal number, for example 1st will become 1.

In some embodiments, date determination module 270 may be configured to account for leap years, such that the date 29 February when expressed as 29/2, which in a non-leap year would be determined to be an invalid date, would, in a leap year, be considered a valid date. Date determination module 270, may be configured, in some embodiments, to account for languages other than English, French and Spanish.

The accounting system 275 may comprise one or more computing devices and/or server devices, such as one or more servers (not shown), databases (not shown), and/or processing devices (not shown) in communication over a network (not shown). The accounting system 275 may be configured to provide accounting services to users, such as entities and accounts, and to maintain accounts for a plurality of entities, such as businesses, individuals and organisations. For example, the accounting system 231 may be used by an accounting services provider such as an accountant, and used to track payer data and invoice data generated with respect to clients of the accounting services provider, such as business entities.

According to some embodiments, the accounting system 275 may comprise a cloud based server system. The accounting system 275 may further comprise a processor (not shown) in communication with a memory (not shown). The processor (not shown) may comprise one or more data processors for executing instructions, and may comprise one or more microprocessor based platforms, central processing units (CPUs), application specific instruction set processors (ASIPs), application specific integrated circuits (ASICs), suitable integrated circuits, or other processors capable of fetching and executing instruction code as stored in the memory. The processor (not shown) may include an arithmetic logic unit (ALU) for mathematical and/or logical execution of instructions, such as operations performed on the data stored in internal registers of the processor.

The accounting system 275 may be configured to receive and/or store data related to one or more invoices issued by an entity to a client or customer; a list of transactions between entities, such as of a bank account or a credit card, an inventory list reciting inventory on hand and/or any fulfilled orders related to said inventory and/or any other type of document that may comprise information ordered by date or otherwise containing date information. Invoice data may include a unique invoice identifier, such as an invoice number. Invoice data may also include one or more of a payment date, payment deadline, payment amount, discount amount, tax amount and unique client or invoice identifier. The unique client identifier may include one or more of the client name, client contact information such as a telephone number, a company registration number (such as an ABN or ACN) or a number generated by the accounting system 231 to uniquely identify the client.

Transaction data, such as what may be included in a transaction document may comprise, a date range over which the transactions have been recorded. Transaction data may comprise entities involved in the transactions, this may be entities that have sent or received money from another entity. Transaction data may comprise a starting balance and a closing balance and/or any other financial data associated with the transactions, such as the amounts of transactions. Transaction data may comprise a date that a transaction was posted, such as the date a purchase/payment was made, and/or a date a transaction was accepted and/or confirmed, such as the date funds were withdrawn and/or transferred between financial accounts. may Inventory lists may comprise inventory data, such as an amount of inventory on hand, a unit cost of one or more inventory items and/or a total value associated with a total number of available inventory. Inventory data may comprise orders to receive or dispatch inventory, orders may include one or more numbers and/or types of inventory and receiver data. Receiver data may comprise an address, an entity name and/or a signatory name.

The accounting system 275 may also be configured to store data relating to payers associated with the business entity, such as clients and customers to whom invoices are issued, whom transactions have been made with and/or whom inventory has been sent to or received from. Payer data may include one or more of the payer name, payer contact information such as a telephone number, a company registration number (such as an ABN or ACN) or a payer identifier such as a payer account number.

The accounting system 275 may be configured to execute functions such as receiving, importing, reading and/or writing invoice, transaction, payee and/or payer data and communicating with date information system 245 to receive date datasets. The accounting system 275, in some embodiments, may be configured to execute functions such as receiving, importing, reading and/or writing orders for inventory to be sent out or received, and/or managing numbers of inventory on hand, communicating with date information system 245 to receive date datasets. This data may be communicated between the accounting system 275, the date information system 245 and/or one or more financial institute or banking servers (not shown). In some embodiments, accounting system 275 may use the data, including the invoice, transaction, invoice, payee data, payer data, inventory data and/or the date data to perform and/or facilitate accounting/bookkeeping and/or business management.

In some embodiments, the date information system 245 resides within or forms part of the accounting system 275 and/or the financial institution, for example.

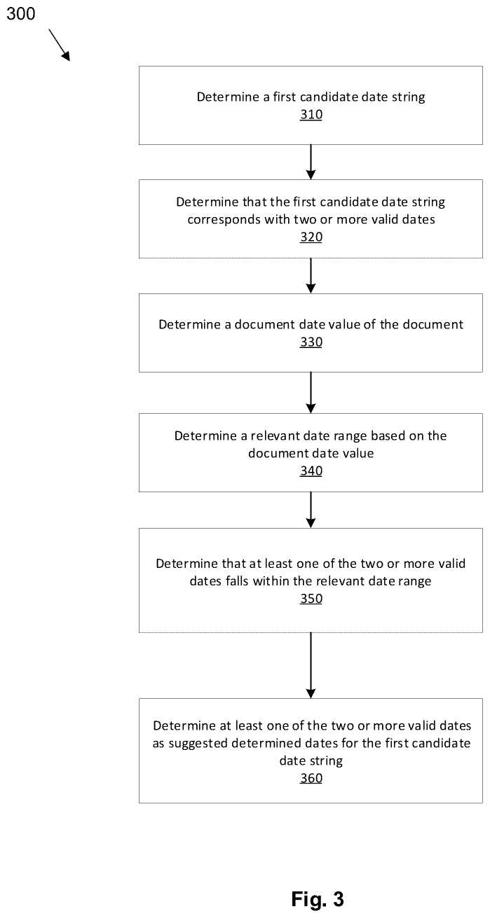

FIG. 3 is a process flow diagram of a method 300 for determining date information from a document, according to some embodiments. The method 300 may be performed by a processor(s) 250 of the date information system 245 executing code module(s) stored in memory 260, for example.

At 310, the system 245 determines a first candidate date string from a document. The first candidate string may be extracted from the document by a machine learning model trained to recognise and determine text. The date string may be a character string comprising alphanumerical characters, digits, text and/or symbols such as hyphens, dashes, forward and/or backward slashes, full stops, brackets and/or commas.

The system 245 may receive the document from a client device 210, a financial institution, an accounting system or a remote server, and/or may retrieve the document from a database. The document may be in a .PDF file or any other appropriate plain text file format. In some embodiments, the document may be an image file, such as a .JPEG or a .BMP.

In some embodiments, the system 245 parses the document to determine, or extract, the first candidate string. In some embodiments, the system may use a parsing module 262 comprising one or more machine learning (ML) models to locate and extract the character strings from the document. The ML model may be an AI model that incorporates deep learning based computation structures, such as artificial neural networks (ANNs). The character string may comprise one or more date elements. Each date element may correspond to a potential day of the month, a potential month or a potential year.

In some embodiments, the system 245 determines or extracts the first candidate date string from the document in accordance with methods disclosed in co-pending Australian provisional patent application 2023XXXXXX, filed on 28 February 2023, and entitled “Methods, systems and computer program products for determining information from image-based documents”, the entire content of which is incorporated herein by reference.

At 320, the system 245 determines that the first candidate string corresponds with two or valid dates. For example, the system may compare the first candidate string with date formats of the date type module 268. The first candidate string corresponds to two valid dates when the string may be interpreted as different dates depending on the date format used. For example, a valid date may be any combination of numbers that may be indicative of a date that, based on the Gregorian calendar and the set of date formats, is possible to exist. For example, a valid date that comprises an indication of the day and an indication of the month may be 25/02, 25 February; this date is also a unique date, as there is no 02/25 in the Gregorian calendar. However, some valid dates may not be unique, as they may correspond to different dates depending on the date format used. For example, the numbers 02/01 may be 2 January or 1 February, depending on the date format intended. However, some dates that may not be valid for a date that comprises a day and a month, may be valid for a date that comprises a month and a year, for example, 02/25 is invalid for a day and month format, but may be indicative of the month of February of the year 2025.

At 330, the system 245 determines a candidate document date value, for example a statement issuance date. For example, the document date value may be the date of issuance or of generation of the document. In some embodiments, the system may be configured to detect, locate or otherwise determine the candidate document date value, such as by locating or determining a specific predetermined location within the document that comprises document date information. In some embodiments, the system may be configured to determine and/or extract the candidate document date value in accordance with methods disclosed in co-pending Australian provisional patent application 2023XXXXXX, filed in the name of Xero Limited, on 28 February 2023, and entitled “Methods, systems and computer program products for determining information from image-based documents”, the entire content of which is incorporated herein by reference. In some embodiments, the additional document data comprise and/or may be used to determine and/or confirm the candidate document date value.

At 340, the system 245 determines a relevant date range of the document based on the candidate document date value. In some embodiments, the document date value comprises the relevant date range. For example, the candidate document date value may indicate a start date and an end date indicative of the period to which the document relates. In some embodiments, the relevant date range extends over a fixed period of time from a start date to the document date value (e.g. the date of issuance or generation of the document). In such embodiments, the system 245 may be configured to determine or calculate the start date of the relevant date range based on the fixed period (which may for example, be a one month period, a six month period, or a year) and the document date value. In some embodiments, document data module 266 may provide document data or meta data that is used to determine the relevant date range of the document, such as a document title and/or document type.

In some embodiments, the system 245 may determine more than one relevant date range, for example a range may be determined based on the additional document data, and/or a default relevant date range. The one or more relevant date ranges may be used to resolve date ambiguity separately, and whichever candidate date range that resolves the most ambiguous dates may be determined to be the relevant date range. In some embodiments, predetermined rules for dates and/or date ranges may be used to determine the relevant date range. For example, a date comprised within an item or a line item, such as a transaction line item, may be within the statement period of the document, as determined by date information contained with the document and/or the additional document data; however a date associated with a transaction line item may be prior to the end of the statement period and no older than 90 days, for example. Different rules may be used depending on the date information of the document and/or the additional document data. The document, in some embodiments, may comprise an explicit indication of the date range; however the explicit indication of the date range may not comprise a start and end date. The explicit indication may comprise a statement such as “Monthly Statement for June 2023” or “Statement for the last 31 days ending Feb 2, 2023”.

At 350, the system 245 determines that at least one of the two or more valid dates falls within the relevant date range. For example, the system may compare the two or more valid dates to the document date range to determine whether at least one of the two or more valid dates falls within the document date range. For example, if the document date range spans from 1 July 2020 to 1 December 2020, and the first candidate date string is 2/7, which may correspond to 2 July or 7 February, as 7 February falls outside of the relevant date range, the only valid date is 2 July.

At 360, responsive to determining that at least one of the two or more valid dates falls within the relevant date range, determining the at least one of the two or more valid dates as an inferred date for the first candidate date string.

In some embodiments, the system 245 may be configured to output the inferred date for the first candidate date string. The system 200 may, in some embodiments be configured to output two or more inferred dates, if the ambiguity of the dates was not able to be resolved, or the dates otherwise had substantially identical likelihoods of being the correctly identified date. In some embodiments, the system 200 may output all potential dates, regardless of the level of confidence of any particular inferred date.

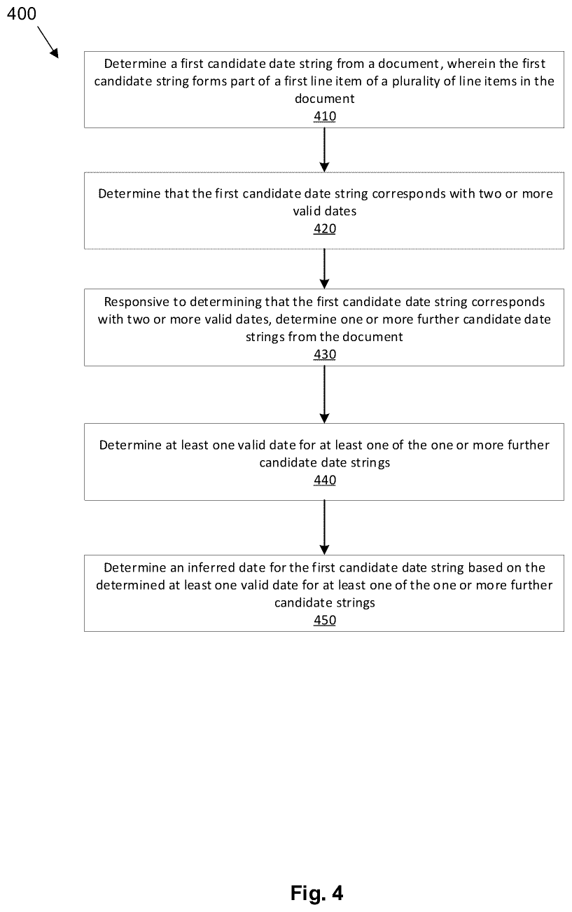

FIG. 4 is a process flow diagram of a method 400 for determining date information from a document, according to some embodiments. The method 400 may be performed by a processor(s) 250 of the date information system 245 executing code module(s) stored in memory 260, for example.

At 410, the system 245 determines or extracts a first candidate date string from a document. The first candidate string may be extracted from the document by a machine learning model trained to recognise and determine text. The first candidate date string forms part of a first item, such as a line item or list item, of a plurality of items in the document. The date string may be a character string comprising alphanumerical characters, digits, and/or text.

The system 245 may receive the document from a client device 210, a financial institution, an accounting system or a remote server, and/or may retrieve the document from a database. The document may be in a .PDF file or any other appropriate plain text file format. In some embodiments, the document may be an image file, such as a .JPEG or a .BMP.

In some embodiments, the system 245 parses the document to determine and/or extract the first candidate string. In some embodiments, the system may use a parsing module 262 comprising one or more machine learning (ML) models to locate and extract the character strings from the document. The ML model may be an AI model that incorporates deep learning based computation structures, such as artificial neural networks (ANNs). The character string may comprise one or more date elements. Each date element may correspond to a potential day of the month, a potential month or a potential year.

In some embodiments, the system 245 determines or extracts the first candidate date string from the document in accordance with methods disclosed in co-pending Australian provisional patent application 2023XXXXXX, filed in the name of Xero Limited, on 28 February 2023, and entitled “Methods, systems and computer program products for determining information from image-based documents”, the entire content of which is incorporated herein by reference.

At 420, the system 245 determines that the first candidate string corresponds with two or valid dates. For example, the system may compare the first candidate string with date formats of the date type module 268. The first candidate string corresponds to two valid dates when the string may be interpreted as different dates depending on the date format used.

At 430, responsive to determining that the first candidate string corresponds with two or more valid dates, the system 245 determines one or more further candidate date strings from the document. Each of the further candidate date string(s) form part of a respective further item such as a further line item or list item of the plurality of items in the document. In some embodiments, the system 245 determines or extracts the further candidate date string(s) in response to determining that the first candidate string corresponds with two or more valid dates. In some embodiments, the system 200 determines or extracts candidate strings from at least some, or all of the plurality of items in the document in a batch process, and retrieves or determines the candidate strings the further candidate date string(s) as required.

At 440, the system 245 determines at least one valid date for at least one of the one or more further candidate date strings. For example, the system may use a similar technique to that described above with respect to method 300.

At 450, the system 245 determines an inferred date for the first candidate date string based on the determined at least one valid date for the at least one of the one or more further candidate date strings.

At least one valid date of each of the plurality of further candidate date strings may comprise at least a first digit, or a first element comprising one or more digits, in a first position and a second digit, or a second element comprising one or more digits, in a second position. For example, the first digit/element may represent a month or a year. In some embodiments, the system 245 determines a greatest number of the plurality of further candidate date strings having the same first value for the first digit/element of the respective valid dates. In response to determining that first value corresponds to a value of a digit/element of the candidate date string, the system may infer that the first digit/element is the month or year of the candidate date string. For example, if the first digit/element in a first position of the character string of a number of items, such as line items or list items, is the same, there is an increased likelihood that the first digit/element represents a month or a year, and that second digit/element is something more likely to change from item to item, such as a day.

In some embodiments, the plurality of items are ordered in date order from earliest date to latest date. The system 245 may determine that a first further candidate date string of the further candidate date string(s) precedes or follows the candidate date string in the order of the plurality of items. The system may then determine an inferred date for the first candidate date string based on the determined valid date(s) for the first further candidate string and whether it precedes or follows the candidate date string. For example, if the first further date candidate string precedes the first candidate date string in order of date, then the system may use this information to better infer the candidate date string as it must occur after the valid date(s) of the first further date candidate string.

In some embodiments, the system 245 may determine both a first further candidate date string and a second further candidate string from the document. The first further candidate date string may precede the candidate date string in the plurality of items, such as line items or list items, and the second further candidate date string may follow or be subsequent to the candidate date string in the plurality of items. For example, if the system determines valid date(s) for a date string of a preceding and following item, the system may be configured to determine that the best inferred date for the candidate date string is one which falls within a range spanning the valid date(s) (or combinations thereof) dates of the date strings of the preceding and following items.

In some embodiments, the system 245 may determine a unique valid date for the first further and/or the second further candidate string. For example, if the system determines a unique valid date for a date string of an item preceding or following the candidate date string, the date format of the items of the documents may be inferred, which may allow the system to resolve other, and in some cases all candidate date strings, such as if it is determined that the date format follows the day and then month format, other formats, such as the month then day format may be removed as potential formats of the character date strings, thereby resolving some or all of the character date strings in the document.

In some embodiments, if one or more candidate string comprises an indication of the day of the week, such as “Tuesday”, “Tue” or “Tues”, and the ordering of day and month is ambiguous, such as the candidate date string “Tuesday 07/02/2023” the system may determine if what days of the week 7 February and 2 July are indicative of. Accordingly, the system may determine that 7 February is a Tuesday, while 2 July is a Sunday, thereby resolving the ambiguity of the candidate date. In some embodiments, if the candidate date string comprises a day of the week indication, the indication may be removed prior to and/or subsequent to processing. In some embodiments, the removed indications may be determined as date parsing metadata.

In some embodiments, the system 200 may be configured to determine a history of processed documents, such us by using machine learning techniques to determine document formatting and/or content trends, and determine therefrom a ‘best guess’ or ‘standard’ date format to be used based on one or more document characteristics. Document characteristics may be related to the additional document data, such as document type and/or entity that generated the document or is associated with the document, such as a bank or other financial institution. Document characteristic may comprise locations of key elements, such as the document date string, recognisable logos and/or positioning of other elements of the document. The suggested date formats as determined by the determined formatting and/or content trends may be an initial guess for resolving ambiguity and may be changed and/or adapted based on valid and/or unambiguous/unique dates determined from the document.

In some embodiments, the system 245 may be configured to use additional document data, which may be received from client device 210, database 240 accounting system 275 and/or accounting system 275 to resolve ambiguity of one or more dates. Additional document data my comprise a document title, a known document date range, a document type, a date/time of creation, an entity that created the document, an entity that is associated with the document, payment deadlines or any other data that may be relevant to the document. For example, if a document type is a “monthly bank statement for January 2023”, the system may be configured to determine that none of the dates in the document will be later than 31 January 2023, or older than 30 days before 1 January 2023, for example.

In some embodiments, the system 245 is configured to use additional document data in combination with date parsing metadata, such as year clarity (e.g. the number of digits the string element that was determined to be indicative of year comprised), date element ordering, such as month/day ordering, confidence rating, and/or a list of potential and/or considered date formats to determine dates of the document. For example, if a date parsing metadata indicates that the date range was determined from a candidate document date string where the document date was represented by two digits, for example “23”, the system 200 may be configured to check the additional document data to determine whether the year is correct, based on a document title and/or document type.

Determining dates from the candidate date strings may comprise any one or more of the above described techniques. The determined dates may be output to a user, or to an application, for example, for downstream processing, such as performing an automated reconciliation action in the accounting system 275.

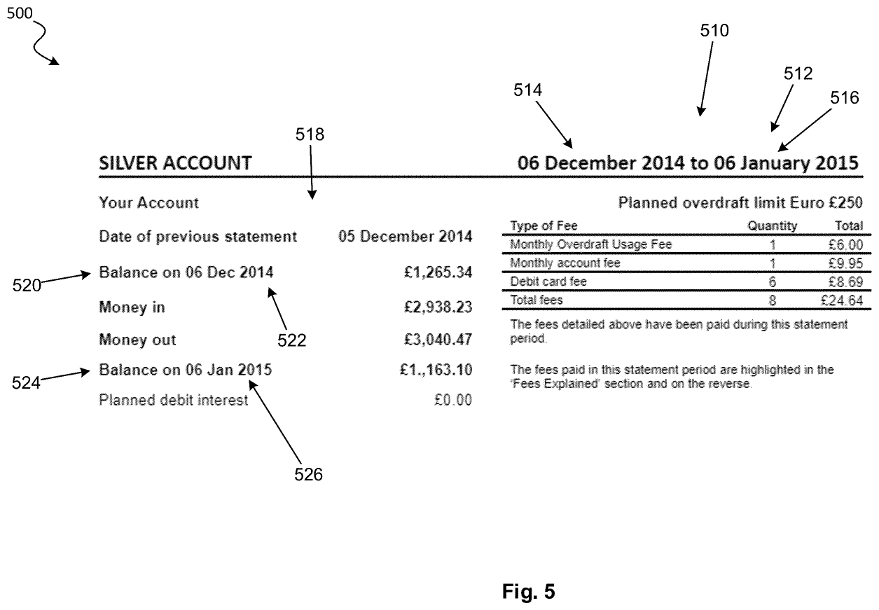

FIG. 5 is an example image of a financial document 500 from which date information may be determined by method 300 or method 400, according to some embodiments. Financial document 500 may comprise document date region 510, which may comprise document date information 512, and line item region 518 which may comprise line items 520, 524. Document date information 512 may comprise start date 514 and end date 516, start and end dates 514, 516 may be indicative of a date range over which the contents of the document 500 is recorded over or indicative of. In some embodiments, document 500 may only comprise start date 514 or end date 516. Document date information 512, when only start or end dates 514, 516 are present, may comprise an explicit declaration of time, such as “31 days from 06 January 2015” (not shown). The date range may be determined from start date 514 and end date 516 according to step 340. Line items 520, 524 of line item region 518 may comprise line item dates 522, 526, indicative of a date associated with the line items 520, 524. Line item dates 522, 526 may be determined at method steps 330 and 350, based on the date range derived from start date 514 and/or end date 516.

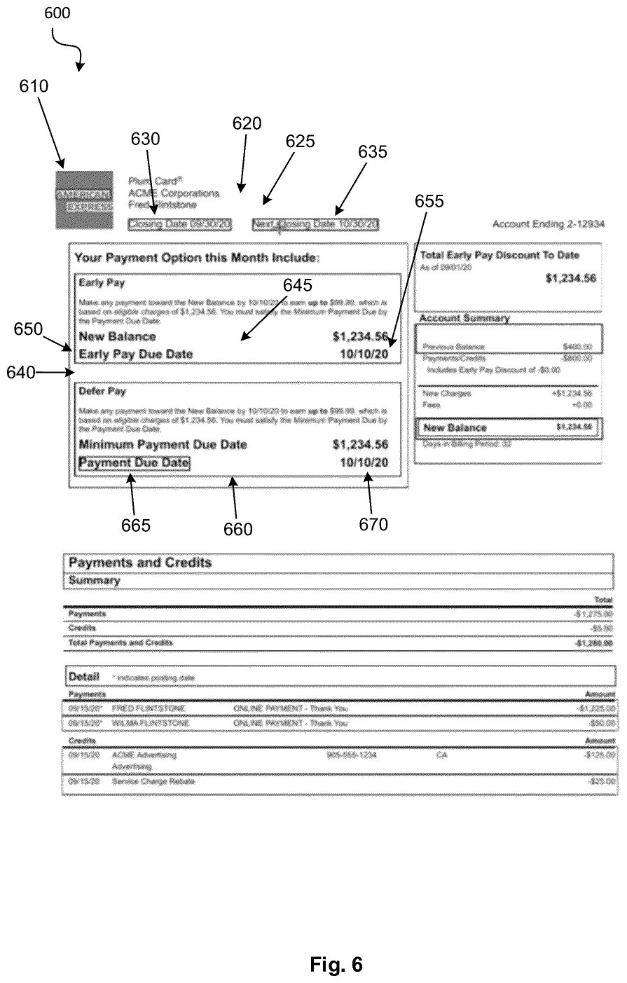

FIG. 6 is an example image of financial document 600, from which date information may be determined by method 300 or method 400, according to some embodiments. Financial document 600 may comprise logo 610, document date region 620, additional document information region 640 and/or line item region 674. Logo 610 may be used to determine a document format and/or one or more expected date formats for document 600 based on other documents bearing logo 610. Document date region 620 may comprise document date information 625, which comprises start date 630 and end date 635, start and end dates 630, 635 may be indicative of a date range over which the contents of the document 600 is recorded over or indicative of. The date range may be derived according to method 300, in particular step 340. Additional document data region 640 may comprise additional document information entries 645 and 660, indicative of additional information 650, 665 relating to document 600 and/or contents comprised therein. Addition information 650 indicates that there is an early payment date for document 600, as indicative by additional date 655. Additional information 665 indicates that the payment due date, that is not an early payment due date is due by additional date 670. Additional information entries 645, 660 may be used to resolve ambiguity of one or more candidate line item dates and/or the document date and/or date range. Line item date region 675 of document 600 comprises line items.

Documents 500, 600 may be parsed to determine and/or extract candidate date strings according to any of the methods described herein. In some embodiments, the dates determined from documents 500, 600 may be communicated to a user, or to an application, for example, for downstream processing, such as performing an automated reconciliation action in an accounting system.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

What is claimed is:

1. A method comprising:
determining a first candidate date string from a document;
determining that the first candidate date string corresponds with two or more valid dates;
determining a document date value of the document;
determining a relevant date range based on the document date value;
determining that at least one of the two or more valid dates falls within the relevant date range; and
responsive to determining that at least one of the two or more valid dates falls within the relevant date range, determining the at least one of the two or more valid dates as an inferred date for the first candidate date string.

2. The method of claim 1, wherein the document date value is a date of issuance of the document.

3. The method of claim 2, wherein the relevant date range extends over a fixed period of time from a start date to the date of issuance of the document.

4. The method of claim 1, wherein the document date value comprises the relevant date range.

5. The method of claim 1, further comprising:
providing, as an output, the inferred date for the first candidate date string.

6. The method of claim 1, wherein
determining that at least two of the two or more valid dates falls within the relevant date range; and
responsive to determining that at least two of the two or more valid dates falls within the relevant date range, determining the at least two of the two or more valid dates as a set of inferred dates for the first candidate date string.

7. The method of claim 6, further comprising:
providing, as an output, the set of inferred dates for the first candidate date string.

8. A method comprising:
determining a first candidate date string from a document, wherein the first candidate date string forms part of a first item of a plurality of items in the document;
determining that the first candidate date string corresponds with two or more valid dates;
responsive to determining that the first candidate date string corresponds with two or more valid dates, determining one or more further candidate date strings from the document, wherein each of the one or more further candidate date strings form part of a respective further item of the plurality of items in the document;
determining at least one valid date for at least one of the one or more further candidate date strings; and
determining an inferred date for the first candidate date string based on the determined at least one valid date for the at least one of the one or more further candidate date strings.

9. The method of claim 8,
wherein determining one or more further candidate date strings from the document comprises determining a plurality of further candidate date strings from the document, and
wherein the at least one valid date of each of the plurality of further candidate date strings comprises at least a first digit in a first position and a second digit in a second position, wherein the first digit represents a month or a year, the method further comprising:
determining a greatest number of the plurality of further candidate date strings having a same first value for the first digit of respective valid dates;
responsive to determining that first value corresponds to a value of a digit of the first candidate date string, inferring that the first digit is the month or year of the candidate date string.

10. The method of claim 8, wherein the plurality of items are ordered in date order from earliest date to latest date, wherein determining one or more further candidate date strings from the document comprises determining a first further candidate date string, and wherein the method further comprises:
determining that the first further candidate date string precedes or follows the candidate date string in an order of the plurality of items; and
determining an inferred date for the first candidate date string based on the determined at least one valid date for the first further candidate date string and whether it precedes or follows the candidate date string.

11. The method of claim 8, wherein the plurality of items are ordered in date order from earliest date to latest date, wherein determining one or more further candidate date strings from the document comprises determining a first further candidate date string and a second further candidate date string from the document, and wherein the first further candidate date string precedes the candidate date string in the plurality of items, and the second further candidate date string follows the candidate date string in the plurality of items, and wherein the method further comprises:
determining an inferred date for the first candidate date string based on the determined at least one valid date for the first further candidate date string and the second further candidate date string.

12. The method of claim 11, wherein determining at least one valid date for at least one of the one or more further candidate date strings comprises determining a unique valid date for the first further and/or the second further candidate date string.

13. The method of claim 1, further comprising:
determining document data indicative of the document date value of the document, wherein determining the document date value is based on the document data.

14. The method of claim 13, wherein the document data is determined from previously processed documents.

15. The method of claim 13, wherein the document data comprises one or more of:
a document type;
a document title;
a document issuance date;
a document creation date;
a document date range;
an indication of an entity that created the document; and/or
an indication of one or more entities associated with the document.

16. The method of claim 13, further comprising:
determining date parsing metadata; and
wherein determining the document date value of the document is based on the received document data and the date parsing metadata.

17. The method of claim 16, wherein the date parsing metadata comprises:
year clarity;
a date element order;
an indication of characters that have been removed from the first candidate date string and/or the one or more further candidate date strings;
a set of date formats; and/or
a confidence rating.

18. The method of claim 1, further comprising:
determining a second candidate date string from the document;
determining that the second candidate date string corresponds with a valid and unique date; and
responsive to determining that the second candidate date string corresponds with a valid and unique date, determining the valid and unique date as an inferred date for the second candidate date string.

19. A system comprising:
one or more processors; and
memory comprising computer executable instructions, which when executed by the one or more processors, cause the system to perform operations including:
determining a first candidate date string from a document;
determining that the first candidate date string corresponds with two or more valid dates;
determining a document date value of the document;
determining a relevant date range based on the document date value;
determining that at least one of the two or more valid dates falls within the relevant date range; and
responsive to determining that at least one of the two or more valid dates falls within the relevant date range, determining the at least one of the two or more valid dates as an inferred date for the first candidate date string.

20. A computer-readable storage medium storing instructions that, when executed by a computer, cause the computer to perform operations including:
determining a first candidate date string from a document;
determining that the first candidate date string corresponds with two or more valid dates;
determining a document date value of the document;
determining a relevant date range based on the document date value;
determining that at least one of the two or more valid dates falls within the relevant date range; and
responsive to determining that at least one of the two or more valid dates falls within the relevant date range, determining the at least one of the two or more valid dates as an inferred date for the first candidate date string.
